(19) United States
(12) Patent Application Publication
(10) Pub. No.: US 2026/0269997 A1
(43) Pub. Date: Sep. 10, 2026

(54) METHODS AND APPARATUS FOR REDUCING CROSS-LINK INTERFERENCE IN SUB-BAND FULL-DUPLEX COMMUNICATION SYSTEMS

(71) Applicant: MediaTek Singapore Pte. Ltd., Singapore (SG)

(72) Inventors: Rama KIRAN, Bengaluru (IN); Jinesh Parameshwaran NAIR, Bengaluru (IN); Mohammed S Aleabe AL-IMARI, Cambridge (GB); Chien-Hua CHEN, Hsinchu City (TW); Yih-Shen CHEN, Hsinchu City (TW)

(21) Appl. No.: 19/165,978

(22) PCT Filed: May 13, 2024
(86) PCT No.: PCT/CN2024/092840

§ 371 Date: Sep. 16, 2025

(30) Foreign Application Priority Data
May 15, 2023 (IN) 202321034068

(51) Int. Cl. H04L 5/00; H04L 5/14

(52) U.S. Cl. CPC H04L 5/0044; H04L 5/1438

(57) ABSTRACT

Various solutions for reducing cross-link interference (CLI) in sub-band full-duplex (SBFD) communication systems are described. An apparatus may receive a configuration from a network node of a wireless network. The configuration indicates one or more SBFD slots subsequent to a DL-only slot. The apparatus may determine that UL transmissions are scheduled in a first SBFD slot of the one or more SBFD slots. Then, the apparatus may mute the UL transmissions in one or more initial symbols of the first SBFD slot following a DL-only.

### CROSS REFERENCE TO RELATED PATENT APPLICATION(S)

The present disclosure is part of a non-provisional application claiming the priority benefit of India Application No. 202321034068, filed 15 May 2023, the content of which herein being incorporated by reference in its entirety.

### TECHNICAL FIELD

The present disclosure is generally related to mobile communications and, more particularly, to reducing cross-link interference (CLI) in sub-band full-duplex (SBFD) communication systems.

### BACKGROUND

Unless otherwise indicated herein, approaches described in this section are not prior art to the claims listed below and are not admitted as prior art by inclusion in this section.

Time division duplexing (TDD) is a widely used channel access technology in mobile communication systems, such as 4^{th} generation (4G) Long Term Evolution (LTE), and 5th generation (5G) New Radio (NR) systems. This technology is based on the half duplex channel access, where the entire component carrier (CC) bandwidth is used for either downlink (DL) or uplink (UL) in a slot, but not both. Among various TDD formats (which define different DL-to-UL ratios) supported by 5G NR, a fixed DL-heavy TDD format (e.g., DDDSU) is generally preferred in most deployments. In a DL-heavy TDD format, allocation of a limited time duration for UL would result in reduced UL coverage and increased latency. As an enhancement, simultaneous existence of DL and UL transmissions or, more specifically, the SBFD operation at user equipment (UE) side or base station (BS) side within a conventional TDD band is introduced in 3^{rd} Generation Partnership Project (3GPP) Release 18.

SBFD introduces simultaneous UL transmissions in a part of channel bandwidth (CBW) in DL-only slots or DL transmissions in part of CBW in UL-only slot of a legacy TDD frame. These slots where UL transmissions and DL transmissions coexist are referred to as SBFD slots. In a typical SBFD communication system, there may be three slot types, including DL-only slot (denoted by D), UL-only slot (denoted by U), and SBFD slot (denoted by X). The frequency resources of a DL-only slot are available only for DL transmissions, while the frequency resources of an UL-only slot are available only for UL transmissions. Within an SBFD slot, the frequency resources of the slot are shared for both DL and UL transmissions. More specifically, in an SBFD slot, the DL and UL sub-bands are separated by a constant number of resource blocks (RBs), and these RBs are called guard band (GB) RBs which are not considered for any DL/UL data transmission. FIG. 1 illustrates two example scenarios 110 and 120 of SBFD frame structure. Scenario 110 depicts the DUD frame structure in which the CBW is divided into three sub-bands in the SBFD slots and UL signals are transmitted in the central sub-band and DL signals are transmitted in sub-bands at the CBW edges. Scenario 110 depicts the DU frame structure in which the CBW is divided into two sub-bands in the SBFD slots and DL signals are transmitted in the top sub-band and UL signals are transmitted in the bottom sub-band.

In legacy TDD systems, start of the UL transmission time is advanced with respect to the DL frame/slot boundary for the purpose of timing alignment. FIG. 2 illustrates an example scenario 200 of timing advance (TA) in legacy TDD systems. As shown in FIG. 2, a UE (denoted as UEᵢ) typically advances its UL transmission with respect to the DL slot boundary by a duration TA=(N_{TA, offset}+N_{TA})*T_{c}), where N_{TA, offset} is a constant timing advancement component that is decided by the BS, N_{TA} is variable component that depends on the signal propagation delay of the UE, and T_{c} is the reference time in 5G NR.

However, when the timing alignment mechanism in legacy TDD systems is applied to SBFD slots, it will cause signal overlapping with preceding DL-only slot, and the signal overlapping will further cause intra-band CLI to DL receiving UEs in the DL-only slot. If the transmitter at UE performing UL transmission in the SBFD slot is close to the DL receiver of the same UE that is receiving in the preceding DL-only slot or another UE performing DL reception in the preceding DL-only slot, the CLI will be high. As a result, symbol decoding failure may occur due to such interference, and this issue remains even when N_{TA, offset}=0 and N_{TA, offset}>0.

Therefore, there is a need to provide proper schemes and designs to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to intra-band CLI in SBFD communication systems.

In one aspect, a method may involve an apparatus receiving a configuration from a network node of a wireless network, wherein the configuration indicates one or more SBFD slots subsequent to a DL(-only) slot. The method may also involve the apparatus determining that UL transmissions are scheduled in a first SBFD slot of the one or more SBFD slots. The method may further involve the apparatus muting the UL transmissions in initial one or more symbols of the first SBFD slot succeeding a DL-only slot.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a configuration from the network node, wherein the configuration indicates one or more SBFD slots subsequent to a DL(-only) slot. The processor may also perform operations comprising determining that UL transmissions are scheduled in a first SBFD slot of the one or more SBFD slots. The processor may further perform operations comprising muting the UL transmissions in the initial one or more symbols of the first SBFD slot succeeding a DL-only slot.

In yet another aspect, a method may involve a network apparatus transmitting a configuration to an apparatus, wherein the configuration indicates one or more SBFD slots subsequent to a DL(-only) slot. The method may also involve the network apparatus determining that UL transmissions are scheduled in a first SBFD slot of the one or more SBFD slots. The method may further involve the network apparatus muting DL transmissions in one or more last symbols of the DL(-only) slot preceding a SBFD slot.

It is noteworthy that, although description provided herein may be in the context of certain radio access technologies, networks and network topologies such as LTE, LTE-Advanced, LTE-Advanced Pro, 5G, NR, Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting two example scenarios of SBFD frame structure.

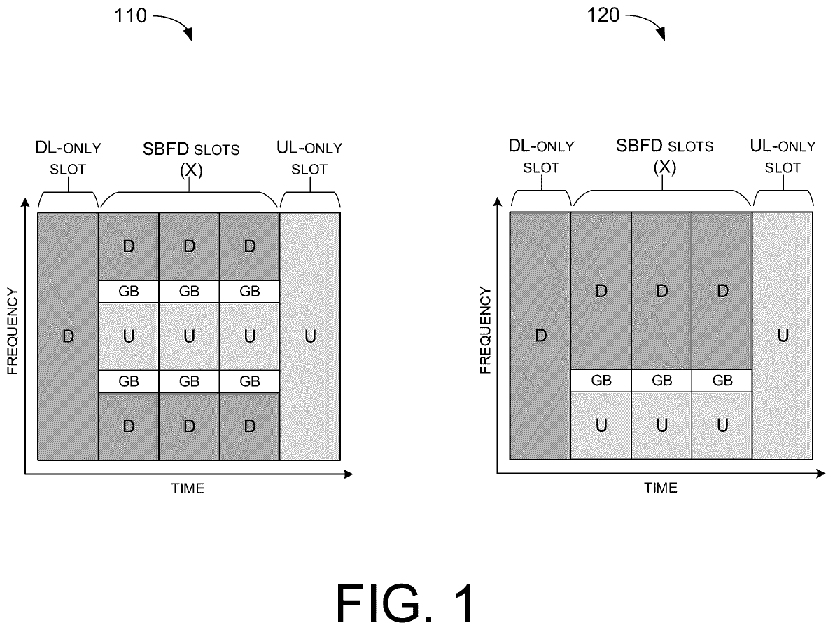

FIG. 2 is a diagram depicting an example scenario of TA in legacy TDD systems.

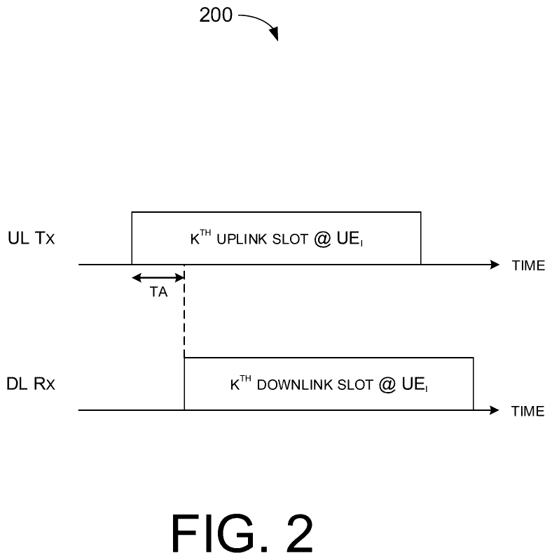

FIG. 3 is a diagram depicting an example scenario of a communication environment in which various solutions and schemes in accordance with the present disclosure may be implemented.

FIG. 4 is a diagram depicting an example scenario of overlapping between the UL transmissions in an SBFD slot and the DL receptions in a DL-only slot in a SBFD system.

FIG. 5 is a diagram depicting an example scenario of UL symbols muting in an SBFD slot by a UE under the first proposed scheme in accordance with an implementation of the present disclosure

FIG. 6 is a diagram depicting an example scenario of DL symbols muting in a DL-only slot by a network node under the second proposed scheme in accordance with an implementation of the present disclosure

FIG. 7 is a diagram depicting an example scenario of DL symbols muting in a DL-only slot by a network node under the second proposed scheme in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reducing CLI in SBFD communication systems. According to the present disclosure, a number of possible solutions may be implemented separately or jointly. That is, although these possible solutions may be described below separately, two or more of these possible solutions may be implemented in one combination or another.

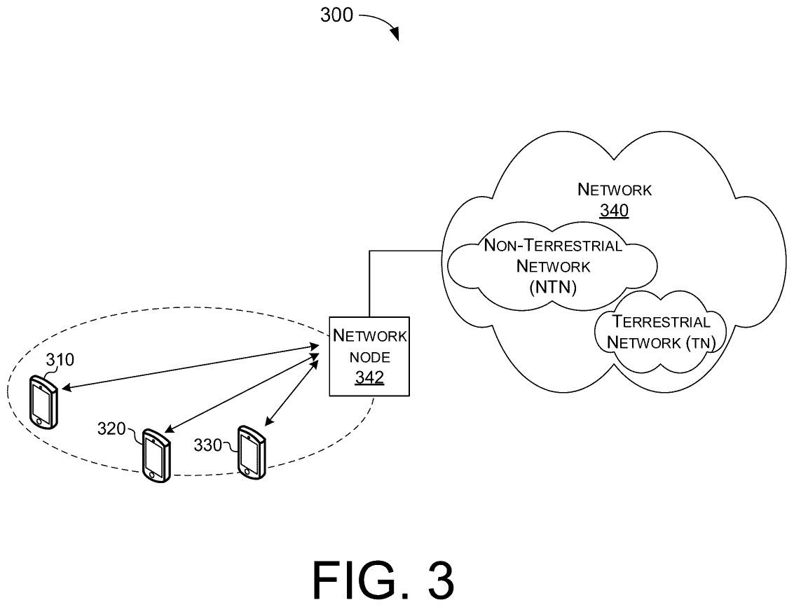

FIG. 3 illustrates an example scenario 300 of a communication environment in which various solutions and schemes in accordance with the present disclosure may be implemented. Scenario 300 depicts an SBFD communication system which involves several UEs (e.g., UEs 310, 320 and 330) in wireless communications with a network 340 (e.g., a wireless network including a non-terrestrial network (NTN) and a terrestrial network (TN)) via a network node 342. The network node 342 may include a terrestrial network node (e.g., an evolved Node-B (eNB), a Next Generation Node-B (gNB), or a transmission/reception point (TRP)) and/or a non-terrestrial network node (e.g., a satellite), depending on network deployment. In such communication environment, the UE 310/320/330, the network 340, and the network node 342 may implement various schemes pertaining to reducing CLI in SBFD communication systems in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

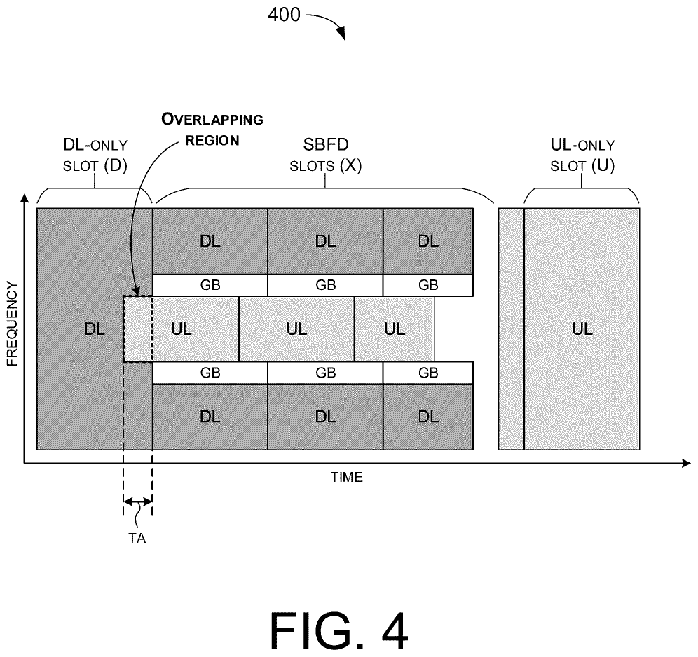

In an SBFD communication system, a slot (called SBFD slot) may be partitioned into sub-bands to accommodate both UL and DL transmissions in the same slot. When the timing alignment mechanism in legacy TDD systems is applied to the SBFD slot where a UE (e.g., UE 310) is performing UL transmissions in one sub-band thereof, it may cause signal overlapping with the preceding DL-only slot where the same UE (e.g., UE 310) or another UE (e.g., UE 320) is performing DL receptions. FIG. 4 illustrates an example scenario 400 of overlapping between the UL transmissions in an SBFD slot and the DL receptions in a DL-only slot in a legacy TDD system. As shown in FIG. 4, the signal overlapping may further cause intra-band inter-UE CLI to another UE (e.g., UE 320) performing DL receptions in the DL-only slot, and/or cause intra-band intra-UE CLI to the same UE (e.g., UE 310) performing DL receptions in the DL-only slot.

In view of the above, the present disclosure proposes a number of schemes pertaining to reducing CLI in SBFD communication systems. Under a first proposed scheme of the present disclosure, an apparatus (e.g., UE) may receive a configuration from a network node (e.g., gNB) of a wireless network (e.g., 5G NR network). Specifically, the configuration indicates one or more SBFD slots subsequent to a DL(-only) slot. Then, the apparatus may determine that UL transmissions are scheduled in a first SBFD slot of the one or more SBFD slots. After that, the apparatus may mute the UL transmissions in the initial one or more symbols of the first SBFD slot. Accordingly, by applying the first proposed scheme of the present disclosure, there will be no overlapping between the UL transmissions in the SBFD slot and the DL receptions in the DL(-only) slot, such that intra-band CLI in SBFD communication systems can be reduced.

In some implementations, the apparatus may also receive control information from the network node, wherein the control information indicates a number of the initial one or more symbols in the SBFD slot that is succeeding DL-only slot. That is, the UL symbols to be muted can be indicated by the control information from the network node. For example, the control information may contain a muting bit pattern that indicates the UL symbols that are to be muted in the first SBFD slot.

In some implementations, the control information may also indicate the first SBFD slot within a frame that is succeeding a DL-only slot. That is, the slot within a frame where the UL symbols muting needs to be applied can be indicated by the control information from the network node. For example, the control information may contain a slot bit pattern that indicates the slot(s) within a frame where the UL symbol muting needs to be applied.

In some implementations, the control information may be received via a radio resource control (RRC) message, a medium access control (MAC) control element (CE), or a downlink control information (DCI).

In some implementations, one or more initial symbols of the SBFD slot succeeding DL-only slot may include one or more physical uplink shared channel (PUSCH) signals, sounding reference signals (SRSs), physical uplink control channel (PUCCH) signals, or physical random access channel (PRACH) signals.

In some implementations, the apparatus may also exclude or include resource elements (REs) corresponding to the one or more muted initial symbols for a transport block size (TBS) computation. Additionally, the apparatus may determine not to perform the UL transmissions in the one or more initial symbols by detecting the SBFD slot that is succeeding a DL-only slot.

In some implementations, the UL transmissions may be scheduled based on a dynamic grant or a configured grant received from the network node.

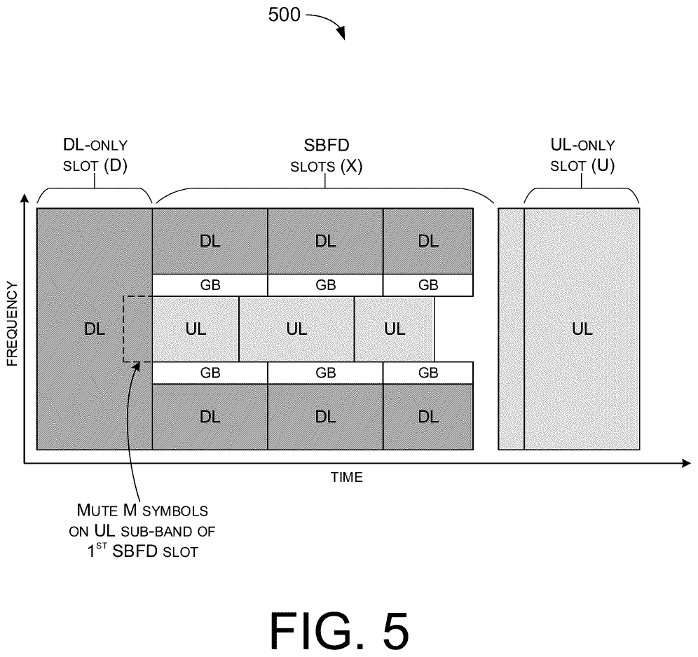

FIG. 5 illustrates an example scenario 500 of UL symbols muting in an SBFD slot by a UE under the first proposed scheme in accordance with an implementation of the present disclosure. Scenario 500 depicts the same DXXXU frame structure as scenario 400, except that the UL transmissions in the first M symbols of the first SBFD slot are muted. In the muted symbols, the UE does not transmit any UL signal. In one example, the muted M symbols may cover the overlapping region between the first SBFD slot and the preceding DL-only slot. In another example, M may be configured with any value greater than or equal to 1. Accordingly, by muting a number of initial symbols in the first SBFD slot, overlapping between the first SBFD slot and the preceding DL-only slot can be avoided to reduce intra-band CLI.

In some implementations, the UL symbols muting may be indicated to the UE by the start and length indicator value (SLIV). For example, the UL symbols muting may be achieved by adding start of symbol values S={1, . . . , M} to a table (e.g., the Table 6.1.2.1-1 in 3GPP technical specification (TS) 38.214) for PUSCH mapping type A and constructing PUSCH time domain allocation list accordingly. For PUSCH mapping type B, the UL symbols muting may be achieved by existing 3GPP specifications.

In some implementations, the time domain position of the first demodulation reference signal (DMRS) symbol may be delayed by N (where N>M) symbols with respect to start of the first SBFD slot. In one example, the value of M is 1 and the value of N is 3 or 4.

Under a second proposed scheme of the present disclosure, a network node (e.g., gNB) may transmit the configuration to an apparatus (e.g., UE). Specifically, the configuration indicates one or more SBFD slots subsequent to a DL(-only) slot. Then, the network node may determine that UL transmissions are scheduled in a first SBFD slot of the one or more SBFD slots. After that, the network node may mute DL transmissions in one or more last symbols of the DL(-only) slot (i.e., not scheduling DL transmissions in these muted symbols). Accordingly, by applying the schemes of the present disclosure, there will be no overlapping between the UL transmissions in the SBFD slot and the DL receptions in the DL(-only) slot, such that intra-band CLI in SBFD communication systems can be reduced.

In some implementations, the muting of the DL transmissions in the one or more last symbols of the DL(-only) slot may include: muting the DL transmission in the one or more last symbols on a sub-band of the DL(-only) slot, wherein the sub-band of the DL(-only) slot overlaps an UL sub-band of the first SBFD slot. Alternatively, the muting of the DL transmissions in the one or more last symbols of the DL(-only) slot may include: muting the DL transmission in the one or more last symbols on a complete band of the DL(-only) slot.

In some implementations, the network node may transmit control information to the apparatus, wherein the control information indicates a number of the one or more last symbols. That is, the DL symbols to be muted can be indicated by the control information from the network node. For example, the control information may contain a muting bit pattern that indicates the DL symbols that are to be muted in the DL(-only) slot.

In some implementations, the control information may indicate the DL(-only) slot within a frame. That is, the slot within a frame where the DL symbols muting needs to be applied can be indicated by the control information from the network node. For example, the control information may contain a slot bit pattern that indicates the slot(s) within a frame where the DL symbol muting needs to be applied. The control information may be transmitted via an RRC message, a MAC CE, or a DCI.

In some implementations, the one or more last symbols of the DL(-only) slot may include one or more physical downlink shared channel (PDSCH) signals, channel state information-reference signals (CSI-RSs), channel state information-interference measurement (CSI-IM) signals, phase tracking-reference signals (PT-RSs), or physical downlink control channel (PDCCH) signals.

In some implementations, the network node may exclude or include REs corresponding to the one or more last symbols for a TBS computation. Additionally, the network node may determine not to perform the DL transmissions in the one or more last symbols.

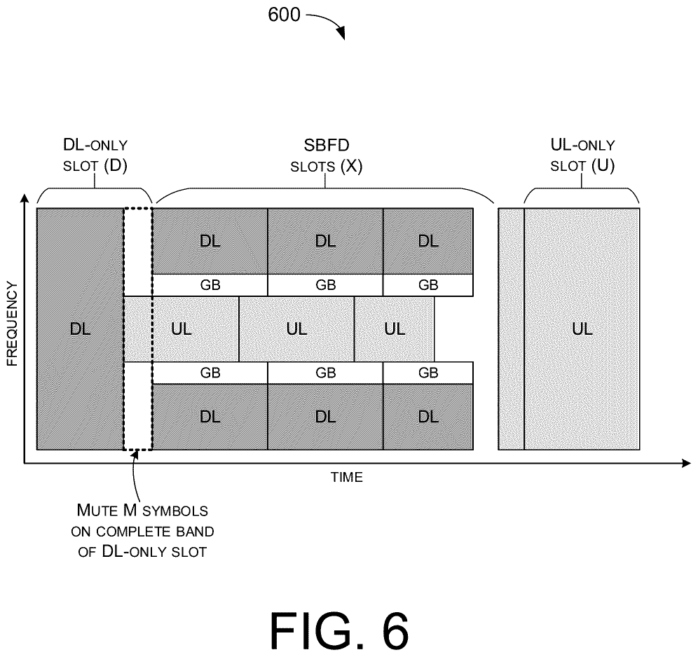

FIG. 6 illustrates an example scenario 600 of DL symbols muting in a DL-only slot by a network node under the second proposed scheme in accordance with an implementation of the present disclosure. Scenario 600 depicts the same DXXXU frame structure as scenario 400, except that the DL transmissions in the last M symbols on the complete band of the DL-only slot are muted. In the muted symbols, the network node does not transmit any DL signal. In one example, the muted M symbols may cover the overlapping region between the DL-only slot and the first SBFD slot. In another example, M may be configured with any value greater than or equal to 1. Accordingly, by muting a number of the last symbols on the complete band of the DL-only slot, overlapping between the DL-only slot and the first SBFD slot can be avoided to reduce intra-band CLI.

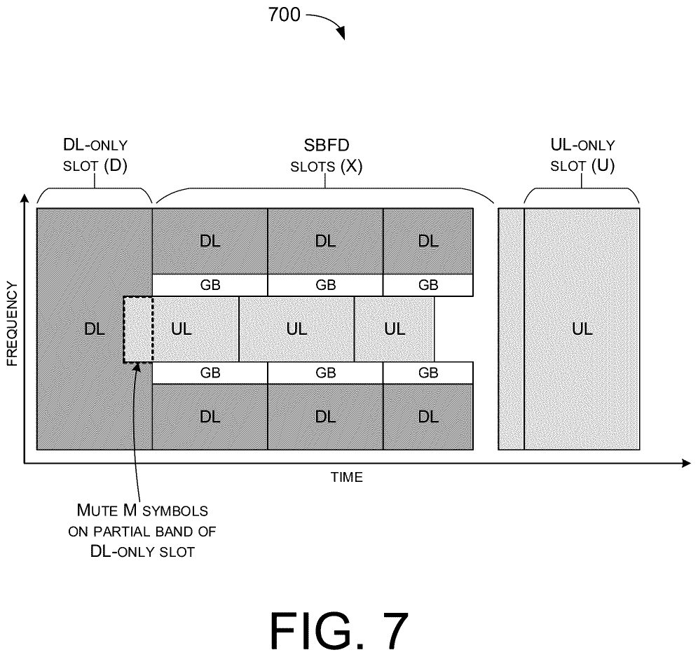

FIG. 7 illustrates an example scenario 700 of DL symbols muting in a DL-only slot by a network node under the second proposed scheme in accordance with an implementation of the present disclosure. Scenario 700 depicts the same DXXXU frame structure as scenario 600, except that only the DL transmissions in the last M symbols on the overlapping sub-band (i.e., the region overlapping the UL sub-band of the first SBFD slot) of the DL-only slot are muted. In the muted symbols, the network node does not transmit any DL signal. In one example, the muted M symbols may cover the overlapping region between the DL-only slot and the first SBFD slot. In another example, M may be configured with any value greater than or equal to 1. Accordingly, by muting a number of the last symbols on a partial band of the DL-only slot, overlapping between the DL-only slot and the first SBFD slot can be avoided to reduce intra-band CLI.

In some implementations, the DL symbols muting may be indicated to the UE(s) by the SLIV.

In some implementations, the UE may detect the last M symbols of the DL-only slot by itself and determine these M symbols as invalid symbols (i.e., the UE may discard these symbols by not decoding them) and the DL receptions in these M symbols as muted, without any assistance from the network node.

### Illustrative Implementations

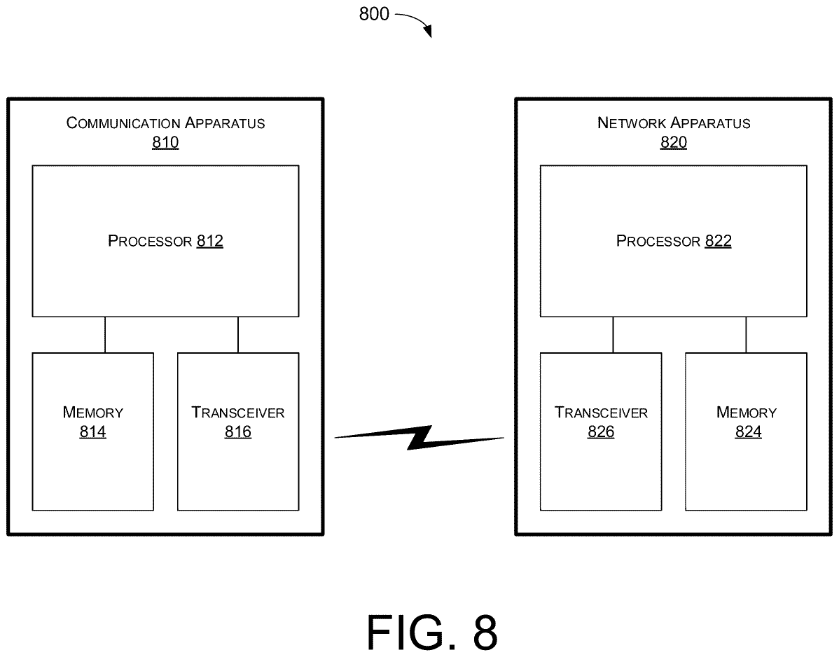

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to reducing CLI in SBFD communication systems, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 810 may also be a part of a machine type apparatus, which may be an IoT, NB-IoT, IIoT UE such as an immobile or a stationary apparatus, a home apparatus, a roadside unit (RSU), a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a BS (e.g., an eNB, a gNB, or a TRP), a satellite, a small cell, a router or a gateway of a wireless network (e.g., a 4G/5G/B5G/6G network). For instance, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks, including reducing CLI in SBFD communication systems, in a UE (e.g., as represented by communication apparatus 810) and a network node (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, transceiver 816 may be capable of wirelessly communicating with different types of UEs and/or wireless networks of different RATs, e.g., 2G GSM, 3G UMTS, 4G LTE, 5G NR, and/or 6G. In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, network apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, communication apparatus 810 may further include a memory 814 coupled to processor 812 and capable of being accessed by processor 812 and storing data therein. In some implementations, network apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 810 and network apparatus 820 may be a communication entity capable of communicating with each other using various proposed schemes in accordance with the present disclosure. For illustrative purposes and without limitation, a description of capabilities of communication apparatus 810, as a UE, and network apparatus 820, as a network node (e.g., a BS), is provided below.

Under the first proposed scheme in accordance with the present disclosure with respect to reducing CLI in SBFD communication systems, processor 812 of communication apparatus 810 may receive, via transceiver 816, a configuration from network apparatus 820, wherein the configuration indicates one or more SBFD slots subsequent to a DL(-only) slot. Then, processor 812 may determine that UL transmissions are scheduled in a first SBFD slot of the one or more SBFD slots. After that, processor 812 may mute the UL transmissions in one or more first symbols of the first SBFD slot.

In some implementations, processor 812 may also receive, via transceiver 816, control information from network apparatus 820, wherein the control information indicates a number of the one or more initial symbols.

In some implementations, the control information may indicate the SBFD slot succeeding a DL-only slot within a frame.

In some implementations, the control information may be received via an RRC message, a MAC CE, or a DCI.

In some implementations, the one or more first symbols of the first SBFD slot may include one or more PUSCH signals, SRSs, PUCCH signals, or PRACH signals.

In some implementations, processor 812 may also exclude or include REs corresponding to the one or more first symbols for a TBS computation. Additionally, processor 812 may determine not to perform the UL transmissions in the one or more initial symbols.

In some implementations, the UL transmissions may be scheduled based on a dynamic grant or a configured grant received from network apparatus 820.

Under the second proposed scheme in accordance with the present disclosure with respect to reducing CLI in SBFD communication systems, processor 822 of network apparatus 820 may transmit, via transceiver 826, a configuration to communication apparatus 810, wherein the configuration indicates one or more SBFD slots subsequent to a DL(-only) slot. Then, processor 822 may determine that UL transmissions are scheduled in a first SBFD slot of the one or more SBFD slots. After that, processor 822 may mute DL transmissions in one or more last symbols of the DL(-only) slot.

In some implementations, the muting of the DL transmissions in the one or more last symbols of the DL(-only) slot may include: muting the DL transmission in the one or more last symbols on a sub-band of the DL(-only) slot, wherein the sub-band of the DL(-only) slot overlaps an UL sub-band of the first SBFD slot. Alternatively, the muting of the DL transmissions in the one or more last symbols of the DL(-only) slot may include: muting the DL transmission in the one or more last symbols on a complete band of the DL(-only) slot.

In some implementations, processor 822 may also transmit, via transceiver 826, control information to communication apparatus 810, wherein the control information indicates a number of the one or more last symbols.

In some implementations, the control information may indicate the DL(-only) slot within a frame, or the control information may be transmitted via an RRC message, a MAC CE, or a DCI.

In some implementations, the one or more last symbols of the DL(-only) slot may include one or more PDSCH signals, CSI-RSs, CSI-IM signals, PT-RSs, or PDCCH signals.

In some implementations, processor 822 may also exclude or include REs corresponding to the one or more last symbols for a TBS computation. Additionally, processor 822 may also determine not to perform the DL transmissions in the one or more last symbols.

### Illustrative Processes

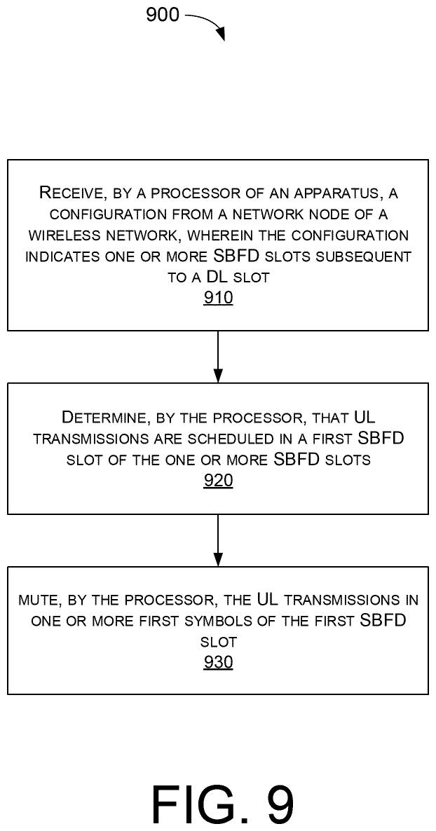

FIG. 9 illustrates an example process 900 in accordance with an implementation of the present disclosure. Process 900 may be an example implementation of above scenarios/schemes, whether partially or completely, with respect to reducing CLI in SBFD communication systems. Process 900 may represent an aspect of implementation of features of communication apparatus 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by or in communication apparatus 810 or any suitable UE or machine type devices. Solely for illustrative purposes and without limitation, process 900 is described below in the context of communication apparatus 810 as a UE and network apparatus 820 as a network node. Process 900 may begin at block 910.

At 910, process 900 may involve processor 812 of communication apparatus 810 receiving, via transceiver 816, a configuration from network apparatus 820, wherein the configuration indicates one or more SBFD slots subsequent to a DL-only slot. Process 900 may proceed from 910 to 920.

At 920, process 900 may involve processor 812 determining that UL transmissions are scheduled in a first SBFD slot of the one or more SBFD slots. Process 900 may proceed from 920 to 930.

At 930, process 900 may involve processor 812 muting the UL transmissions in one or more initial symbols of the first SBFD slot.

In some implementations, process 900 may further involve processor 812 receiving, via transceiver 816, control information from network apparatus 820, wherein the control information indicates a number of the one or more first symbols.

In some implementations, the control information may indicate the first SBFD slot within a frame.

In some implementations, the control information may be received via an RRC message, a MAC CE, or a DCI.

In some implementations, the one or more first symbols of the first SBFD slot may include one or more PUSCH signals, SRSs, PUCCH signals, or PRACH signals.

In some implementations, process 900 may further involve processor 812 excluding or including REs corresponding to the one or more first symbols for a TBS computation. Additionally, process 900 may involve processor 812 determining not to perform the UL transmissions in the one or more first symbols.

In some implementations, the UL transmissions may be scheduled based on a dynamic grant or a configured grant received from network apparatus 820.

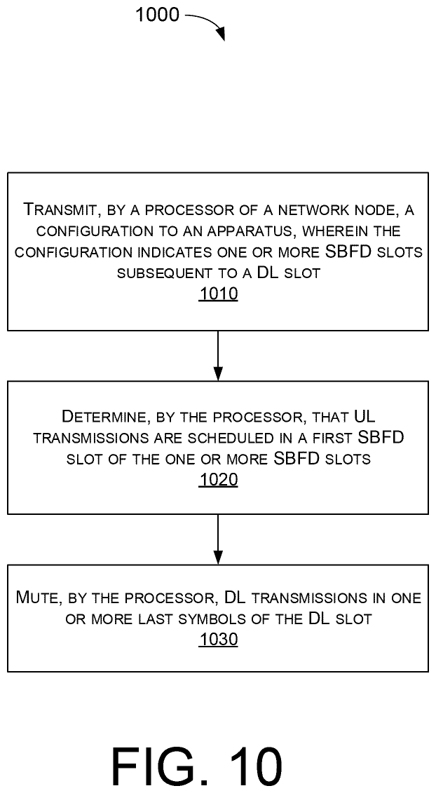

FIG. 10 illustrates an example process 1000 in accordance with an implementation of the present disclosure. Process 1000 may be an example implementation of above scenarios/schemes, whether partially or completely, with respect to reducing CLI in SBFD communication systems. Process 1000 may represent an aspect of implementation of features of network apparatus 820. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by or in network apparatus 820 (e.g., BS) or any suitable network node (e.g., satellite). Solely for illustrative purposes and without limitation, process 1000 is described below in the context of communication apparatus 810 as a UE and network apparatus 820 as a network node. Process 1000 may begin at block 1010.

At 1010, process 1000 may involve processor 822 of network apparatus 820 transmitting, via transceiver 826, a configuration to communication apparatus 810, wherein the configuration indicates one or more SBFD slots subsequent to a DL slot. Process 1000 may proceed from 1010 to 1020.

At 1020, process 1000 may involve processor 822 determining that UL transmissions are scheduled in a first SBFD slot of the one or more SBFD slots. Process 1000 may proceed from 1020 to 1030.

At 1030, process 1000 may involve processor 822 muting DL transmissions in one or more last symbols of the DL slot.

In some implementations, the muting of the DL transmissions in the one or more last symbols of the DL slot may include: muting the DL transmission in the one or more last symbols on a sub-band of the DL slot, wherein the sub-band of the DL slot overlaps an UL sub-band of the first SBFD slot. Alternatively, the muting of the DL transmissions in the one or more last symbols of the DL slot may include: muting the DL transmission in the one or more last symbols on a complete band of the DL slot.

In some implementations, process 1000 may further involve processor 822 transmitting, via transceiver 826, control information to communication apparatus 810, wherein the control information indicates a number of the one or more last symbols.

In some implementations, the control information may indicate the DL slot within a frame, or the control information may be transmitted via an RRC message, a MAC CE, or a DCI.

In some implementations, the one or more last symbols of the DL slot may include one or more PDSCH signals, CSI-RSs, CSI-IM signals, PT-RSs, or PDCCH signals.

In some implementations, process 1000 may further involve processor 822 excluding or including REs corresponding to the one or more last symbols for a TBS computation. Additionally, process 1000 may involve processor 822 determining not to perform the DL transmissions in the one or more last symbols.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration from a network node of a wireless network, wherein the configuration indicates one or more sub-band full-duplex (SBFD) slots subsequent to a downlink (DL) slot;
determining, by the processor, that uplink (UL) transmissions are scheduled in a first SBFD slot of the one or more SBFD slots; and
muting, by the processor, the UL transmissions in one or more initial symbols of the first SBFD slot.

2. The method of claim 1, further comprising:
receiving, by the processor, control information from the network node, wherein the control information indicates a number of the one or more initial symbols to be muted.

3. The method of claim 2, wherein the control information indicates the first SBFD slot subsequent to the DL slot within a frame.

4. The method of claim 2, wherein the control information is received via a radio resource control (RRC) message, a medium access control (MAC) control element (CE), or a downlink control information (DCI).

5. The method of claim 1, wherein the one or more initial symbols of the first SBFD slot comprise one or more physical uplink shared channel (PUSCH) signals, sounding reference signals (SRSs), physical uplink control channel (PUCCH) signals, or physical random access channel (PRACH) signals.

6. The method of claim 1, further comprising:
excluding or including, by the processor, resource elements (REs) corresponding to the one or more first symbols for a transport block size (TBS) computation; and
determining, by the processor, not to perform the UL transmissions in the one or more initial symbols.

7. The method of claim 1, wherein the UL transmissions are scheduled based on a dynamic grant or a configured grant received from the network node.

8. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a configuration from the network node, wherein the configuration indicates one or more sub-band full-duplex (SBFD) slots subsequent to a downlink (DL) slot;
determining that uplink (UL) transmissions are scheduled in a first SBFD slot of the one or more SBFD slots; and
muting the UL transmissions in one or more initial symbols of the first SBFD slot.

9. The apparatus of claim 8, wherein, during operation, the processor further performs operations comprising:
receiving, via the transceiver, control information from the network node, wherein the control information indicates a number of the one or more initial symbols to be muted.

10. The apparatus of claim 9, wherein the control information indicates the first SBFD slot subsequent to the DL slot within a frame.

11. The apparatus of claim 9, wherein the control information is received via a radio resource control (RRC) message, a medium access control (MAC) control element (CE), or a downlink control information (DCI).

12. The apparatus of claim 8, wherein the one or more initial symbols of the first SBFD slot comprise one or more physical uplink shared channel (PUSCH) signals, sounding reference signals (SRSs), physical uplink control channel (PUCCH) signals, or physical random access channel (PRACH) signals.

13. The apparatus of claim 8, wherein, during operation, the processor further performs operations comprising:
excluding or including resource elements (REs) corresponding to the one or more initial symbols for a transport block size (TBS) computation; and
detecting SBFD slots succeeding DL-only slots and determining not to perform the UL transmissions in the one or more initial symbols.

14. The apparatus of claim 8, wherein the UL transmissions are scheduled based on a dynamic grant or a configured grant received from the network node.

15. A method, comprising:
transmitting, by a processor of a network node, a configuration to an apparatus, wherein the configuration indicates one or more sub-band full-duplex (SBFD) slots subsequent to a downlink (DL) slot;
determining, by the processor, that uplink (UL) transmissions are scheduled in a first SBFD slot of the one or more SBFD slots; and
muting, by the processor, DL transmissions in one or more last symbols of the DL slot.

16. The method of claim 15, wherein the muting of the DL transmissions in the one or more last symbols of the DL slot comprises:
muting the DL transmission in the one or more last symbols on a sub-band of the DL slot; or
muting the DL transmission in the one or more last symbols on a complete band of the DL slot.

17. The method of claim 15, further comprising:
transmitting, by the processor, control information to the apparatus, wherein the control information indicates a number of the one or more last symbols.

18. The method of claim 17, wherein the control information indicates the DL slot within a frame, or the control information is transmitted via a radio resource control (RRC) message, a medium access control (MAC) control element (CE), or a downlink control information (DCI).

19. The method of claim 15, wherein the one or more last symbols of the DL slot comprise one or more physical downlink shared channel (PDSCH) signals, channel state information-reference signals (CSI-RSs), channel state information-interference measurement (CSI-IM) signals, phase tracking-reference signals (PT-RSs), or physical downlink control channel (PDCCH) signals.

20. The method of claim 15, further comprising:
excluding or including, by the processor, resource elements (REs) corresponding to the one or more last symbols for a transport block size (TBS) computation; and
determining, by the processor, not to perform the DL transmissions in the one or more last symbols.
